(19) United States
(12) Patent Application Publication
(10) Pub. No.: US 2026/0228819 A1
(43) Pub. Date: Aug. 6, 2026

(54) Human-Sovereign Ecosystem Platform

(71) Applicant: FURONG BEI, SAN GABRIEL, CA (US)

(72) Inventor: FURONG BEI, SAN GABRIEL, CA (US)

(21) Appl. No.: 19/201,880

(22) Filed: May 7, 2025

(51) Int. Cl. G06Q 40/02; H04L 9/32

(52) U.S. Cl. CPC G06Q 40/026; H04L 9/3218

(57) ABSTRACT

The invention provides a user-centric integration platform for seamless interaction between end users and a large-scale distributed ecosystem. The platform hides blockchain complexity through dynamic identity layers, adaptive resource mapping, and multi-currency support. A per-user sovereignty digital identity is generated and associated with a registry of subsystem modules mapped to industries, utilities, institutional services, and user need vectors. A seamless user-experience gateway orchestrates digital assets, fiat currencies, CBDCs, off-chain utility networks, data assets, and institutional connectors while enforcing data security, privacy-preserving verification, and dynamic compliance across jurisdictions. The system supports personalized portals, behavior-time-value processing, TimeToken NFTs, cross-domain connectivity APIs, and federated audit logs to provide an extensible human-sovereign ecosystem platform.

### FIELD OF THE INVENTION

This invention relates to distributed ledger technology, secure digital identity frameworks, cross-domain resource orchestration, data security architectures, and user-centric integrated ecosystem platforms.

### BACKGROUND OF THE INVENTION

### Technical Problem

Existing decentralized systems require users to manage private keys, switch networks, understand transaction mechanics, and piece together disjointed services (financial, utilities, governmental), resulting in poor adoption.

### Existing Solutions

MPC-based wallets, gasless relayers, smart contract wallets-yet none simultaneously address ultra-scale multi-service integration, data security, life utilities, and cross-border institutional interoperability.

### SUMMARY OF THE INVENTION

### Identity Management

Identity Abstraction Layer: Generates per-user sovereignty DID, combining MPC, BEISIGN root anchors, social and biometric recovery.

### Resource & Interoperability: Dynamic Ecosystem Mapping

Dynamic Ecosystem Mapping: Maintains a registry of at least 1,700 subsystem modules, three hundred sixty-five industries, nine hundred ninety-nine user vectors, plus core urban utilities (water, electricity, food supply chains).

### Multi-Currency & Resource Interoperability

Multi-Currency & Resource Interoperability: Unified resource manager converging all digital and fiat currencies (including CBDCs), tokens, data assets, and off-chain utilities.

### User Experience & Security

Seamless UX & Service Gateway: Presents human-readable actions across utilities, governance, commerce, and identity, hiding all technical details.

Data Security Framework: End-to-end encryption, ZKP-based proofs, secure hardware enclaves, policy-driven access control and real-time risk assessment.

### Portal & Domain Management

Multi-Domain & Multi-Size Dynamic Portal Generator: Allows each user to create up to nine hundred ninety-nine personalized portals or mini-sites, each aligned to specific needs vectors, with one-click connection to relevant subsystem modules, dynamically sized and themed to user preference.

### Value Dynamics & Tokenization

Behavior-Time-Value (BEI) Engine: Continuously monitors user behavior and platform activity to quantify time and actions into dynamic economic value. Implements a self-learning neural feedback loop-higher ecosystem usage drives increased intelligence and throughput, triggering proportional minting of native tokens and TimeToken NFTs.

TimeToken NFT Framework: Issues non-fungible tokens tied to discrete time segments and user behavior milestones. Tokenized time assets appreciate in value as user engagement scales, with smart contracts adjusting supply and rewards to incentivize sustained ecosystem interaction.

### Platform & Domain Integration Hub

Global Domain Mesh: Integrates Draiglobal.com (Dr AI Global platform), 36JI.com, and over 100 .org domains, along with national and municipal websites, into a unified hub for privacy, security, governance, and analytics.

Cross-Domain Connectivity APIs: Standardized single sign-on, data federation, and governance policy enforcement across all integrated domains.

Federated Privacy & Security Framework: Centralized orchestration of consent, encryption, access control, and audit logs, maintaining domain-specific compliance while enabling global oversight.

Cross-Domain Analytics & Reporting: Aggregates usage, security metrics, and compliance data from all domains, providing real-time dashboards and insights for platform administrators.

### Data Access Chain & Energy-Currency Conversion

This section defines how data access events are recorded on-chain and converted into economic value:

Data Access Chain Layer: Establishes an immutable ledger of data access events (clicks, views, API calls), registering each interaction with timestamps, digital identities (DIDs), and context metadata.

Energy Equivalence Engine: Transforms quantified data access events into “energy units” using calibrated conversion models, mapping user engagement and resource utilization to energy credits.

Currency Conversion Module: Automatically converts energy credits into ecosystem native tokens or TimeToken NFTs according to predefined rate curves, rewarding active participants.

Dynamic Incentive Feedback: Real-time smart contracts adjust conversion rates and bonus multipliers based on network load, seasonal factors, or governance votes, ensuring equilibrium and sustainable token economics.

Adversarial Resilience & Fraud Prevention: Incorporates anomaly detection, reputation scoring, and stake-based slashing to guard against artificial inflation of data events.

Global Domain Mesh: Integrates Draiglobal.com (Dr AI Global platform), 36JI.com, SZBF.com, and over 100 .org domains, along with national and municipal websites, into a unified hub for privacy, security, governance, and analytics.

Cross-Domain Connectivity APIs: Standardized single sign-on, data federation, and governance policy enforcement across all integrated domains.

Federated Privacy & Security Framework: Centralized orchestration of consent, encryption, access control, and audit logs, maintaining domain-specific compliance while enabling global oversight.

Cross-Domain Analytics & Reporting: Aggregates usage, security metrics, and compliance data from all domains, providing real-time dashboards and insights for platform administrators.

### Future-Proof Universal Infrastructure

To ensure platform compatibility with future technologies, this invention includes the following forward-looking architectures:

Interplanetary Network Fabric: A mesh of orbital and deep-space relay nodes using delay-tolerant networking (DTN) protocols, enabling resilient connectivity across planetary distances.

Quantum-Resilient Cryptography: Integration of post-quantum algorithms and hardware-secure quantum key distribution to ensure data integrity and privacy against future quantum adversaries.

Self-Scaling Node Ecosystem: Autonomous node instantiation and retirement using programmable orchestration, allowing infinite horizontal scaling and self-healing across any spatial dimension.

Cross-Dimensional Data Sharding: Multi-layer sharding that partitions data across spatial (planetary, orbital, sub-orbital) and virtual dimensions, ensuring efficient query routing and resource locality.

Time-Abstracted Consensus: Consensus mechanisms that operate across variable time dilation environments, preserving ledger consistency in relativistic contexts.

Infinite Growth Boundaries: Architectural reserves for up to nine magnitudes of network capacity beyond initial deployment, employing elastic resource zones and predictive infrastructure allocation.

Space Resource Integration: Interfaces for mining and allocating extraterrestrial resources (asteroid materials, lunar regolith, solar energy arrays) into the economic grid.

Synthetic Environment Governance: Frameworks for virtual world generation, metaverse layering, and governance across simulated ecosystems, ensuring continuity from physical to digital universes.

### BRIEF DESCRIPTION OF DRAWINGS

FIG. 1 Overall system architecture.

FIG. 2 Identity abstraction and recovery flow.

FIG. 3 Dynamic mapping and orchestration pipeline.

FIG. 4 Data security and institutional integration modules.

FIG. 5 Sample ECO BEI token representation.

FIG. 6 BEI token denomination series including 1, 5, 10, 50, and INF/infinite units.

FIG. 7 TimeToken NFT concept including TimeToken NFT, DNA, and DATA markers.

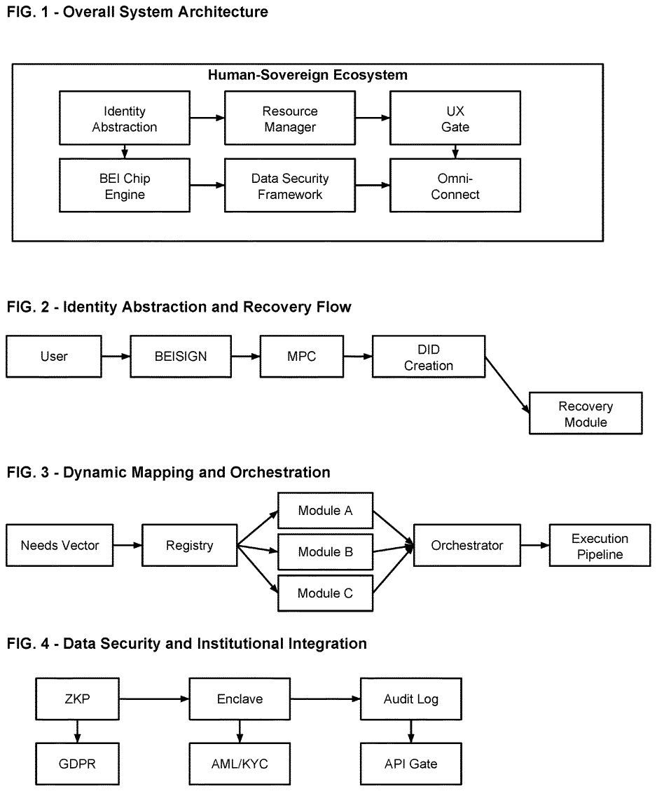

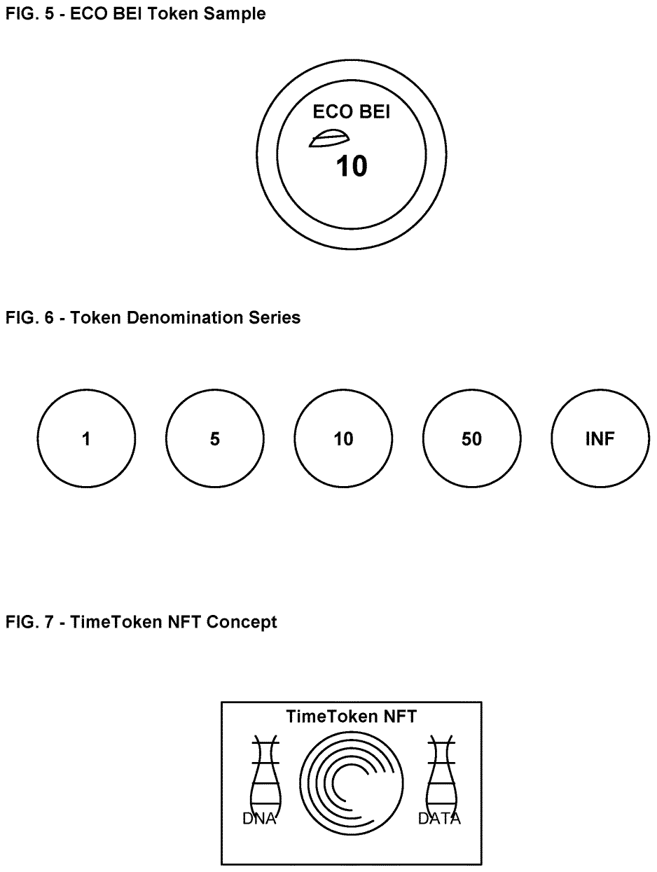

### DETAILED DESCRIPTION OF THE INVENTION

### System Architecture

Identity Abstraction Layer: MPC/WebAuthn combined with BEISIGN root DID anchors, social and biometric recovery modules, ensuring secure, recoverable user identities.

Module Registry: A catalog of at least 1,700 subsystem definitions across three hundred sixty-five industry domains and utility services, enabling dynamic service discovery.

Service & UX Gateway: Human-centric interface coordinating API orchestration, signature relaying, gas abstraction, and cross-chain transaction management.

Resource Manager: Cross-chain bridging, fiat and CBDC rails, SWIFT/SEPA/CIPS connectors, and IoT/utility network integration for unified asset and data flows.

Institutional Integration Hub: Standardized connectors for governmental e-governance, banking KYC/KYB, healthcare EHR, education LMS, and supply-chain ERP.

### Process Flow

Onboarding: User logs in via email, phone, or BEISIGN authentication; a sovereignty DID is generated and securely stored via MPC.

Needs Assessment: An AI-driven profiling engine evaluates nine hundred ninety-nine user vectors and real-time preferences to select appropriate subsystem modules.

Orchestration: The resource manager allocates currencies, utilities, and data channels; the UX gateway presents intuitive confirmation prompts.

Execution: Atomic transactions, permission grants, and service calls are carried out across blockchains, CBDC networks, and institutional systems.

### Infrastructure & Utilities Modules

Water & Energy: Tokenized resource credits, real-time consumption tracking, automated billing, and decentralized governance of supply networks.

Food Distribution: End-to-end DLT-backed traceability, dynamic routing, personalized nutrition profiling, and emergency provisioning protocols.

Urban Services: Seamless integration with municipal systems for transportation scheduling, healthcare appointment management, and academic credential issuance.

### Data Security Framework

End-to-end encryption using AES-256 & TLS; keys managed via MPC.

Zero-Knowledge Proofs: Privacy-preserving attestations for identity, credential verification, and compliance checks.

Secure Enclaves: Hardware-backed isolation for sensitive computations.

Policy-Driven Access: Role-based, attribute-based, and contextual policies govern data sharing.

Quantum Conn-Edit Entity Audit: Quantum-resistant connection editing and entity-level audit trails for forensic traceability under critical security events.

### Currency & Token Design Principles

Token Denomination Series: As shown in (FIG. 6), BEI tokens are minted in standardized units (1, 5, 10, 50, infinite) with consistent iconography, edge engraving, and micro-circuit patterns to facilitate user recognition and security.

TimeToken NFT Concept: Illustrated in (FIG. 7), TimeToken NFTs feature a central nautilus shell spiral signifying continuous temporal value, flanked by stylized DNA strand filigrees and binary code fields, representing the convergence of behavior, data, and value creation.

Adaptive Value Amplification: BEI Engine dynamically adjusts token rewards and NFT valuations based on real-time ecosystem engagement metrics, visualized through color-shift leaf emblems and variable edge patterns.

### User Experience Enhancements

AI-Powered Navigation & Virtual Assistant: Context-aware conversational AI for guided navigation, customer support, and QA across all portals and services.

Interactive Help & Documentation: On-demand smart tooltips, guided workflows, and tutorial bots to assist users in complex tasks.

One-Stop Dashboard: Consolidates identity, assets, utilities, services; multi-language and accessibility compliance.

Personalized Recommendations: AI-based suggestions for services, resource usage, governance participation.

Progressive Decentralization: Users upgrade from custodial to self-sovereign control as they grow.

### Multi-Domain & Multi-Size Portal Hub: Regulatory & Governmental Integration

Compliance Engine: Automatic mapping of platform operations to international, national, regional and local regulations (banking, taxation, anti-money laundering, data privacy), with dynamic rule updates per jurisdiction.

Taxation & Reporting Module: Real-time calculation and filing of taxes for individuals, families, corporations; integration with tax authorities via standardized APIs (e.g., IRD, IRS, HMRC).

Government Interface Connectors: Standardized gateways to national and municipal systems for e-governance, citizen services (ID issuance, social security, permits), urban planning, and public welfare distribution.

Industry-Specific Compliance Layers: Configurable policy modules for finance, healthcare, education, energy, telecom, and other verticals to enforce regulatory standards and audit requirements.

Personal & Family Service Profiles: User-level modules for family allowances, benefits management, health insurance, pension contributions, housing subsidies, with secure data sharing consent flows.

Audit & Certification Hub: On-chain and off-chain audit trails, certification of compliance events, dynamic dashboards for regulators and institutional partners.

### Nation-Building & Governance Modules

Constitutional Framework: Definition of foundational principles, separation of powers, bill of rights, amendment processes.

Governance & Administrative Divisions: Central governance, regional/state governments, local municipalities; election systems and participatory democracy tools.

Monetary System & Central Banking: Design of native digital currency, monetary policy rules, central bank digital currency (CBDC) issuance, inflation targeting, reserves management.

Legal & Judicial System: Codified legal code, smart contract-enforced regulations, dispute resolution via on-chain courts, arbitration mechanisms.

Public Service Infrastructure: Planning and deployment of transportation, communication networks, utilities (water, energy), and digital infrastructure.

Social Welfare & Public Health: Healthcare systems integration, insurance schemes, pension management, family allowances, emergency response protocols.

Education & Research: Curriculum frameworks, accreditation processes, research funding, knowledge-sharing platforms.

Defense & Security: Citizen militias, digital homeland security, cybersecurity defences, crisis management.

Diplomacy & International Relations: Treaty management, cross-border identity recognition, trade agreements, global regulatory harmonization.

Cultural & Community Development: Preservation of languages, arts funding, community grants, festivals and events.

Environmental & Resource Management: Sustainable resource usage, conservation policies, climate resilience modules.

### Data Architecture & Management

Distributed Data Mesh: Each of the 1,700 subsystem modules deploys its own data nodes in a decentralized mesh topology. Data flows dynamically between nodes based on user demand vectors, ensuring high throughput and low latency.

Hierarchical Data Layers: From global aggregates down to microservice-level datasets, with real-time synchronization. Implements multi-tier caching: regional caches, edge caches, and in-memory micro-caches.

Event-Driven Streams: All user actions, resource updates, and inter-module communications are represented as event streams (Kafka or similar), enabling reactive processing, CQRS patterns, and effective auditing.

Data Indexing & Catalog: A federated metadata catalog indexes data by subsystem, industry, user vector, geography, and compliance requirements. Supports dynamic query planning and adaptive query routing.

Data Governance & Policies: Policy engines enforce schema validation, lineage tracking, access control, retention rules, and data anonymization at each node via attribute-based policies and role-based controls.

Scalable Storage Fabric: Combines object storage (for large artifacts), time-series databases (for usage metrics), graph databases (for relationship mapping), and relational/NoSQL stores (for transactional data).

Cross-Module Analytics: AI-driven analytics pipelines ingest data from multiple subsystems to generate insights, predictions, and personalized recommendations in real time.

Resilience & Recovery: Automated failover, geo-replication, and self-healing mechanisms support high availability; real-time backups with point-in-time recovery.

### BEI Chip Engine & Core Key Module

Adaptive Acceleration Fabric: A hardware-software co-designed chip (BEI Chip) embedding specialized ASIC/FPGA modules for cryptographic operations, consensus verification, and AI inference tasks. Through parallel pipelines, each transaction and data routing is processed at nanosecond scale, enabling throughput >10M TPS.

Self-Optimizing Neural Engine: Integrated on-chip learning module monitors network patterns, user behavior, and ecosystem state. It dynamically reconfigures processing blocks and cache hierarchies to reduce latency by 50% on average with continuous feedback loops.

Token Incentive Feedback Loop: On-chip counters measure compute and network contributions; smart contracts auto-mint native tokens proportional to BEI Chip usage intensity, providing real-time economic rewards and motivating decentralized node participation.

Microservice Offload Interface: Standardized PCIe/CXL protocol for subsystem modules to offload heavy computations onto the BEI Chip, reducing host CPU load and enabling seamless scaling of secondary ecosystems.

Secure Key Vault & Root of Trust: Hardware-enforced secure enclave within the BEI Chip stores critical root keys and identity anchors (BEISIGN shares). All critical operations (signatures, decryption) occur inside the enclave, impervious to external attacks.

Energy-Efficient Design: Utilizing advanced process nodes and on-chip power gating, the BEI Chip maintains >90% performance per watt efficiency, supporting large-scale global deployment in data centers and edge devices.

### Banking Clearing & ATMS.com Integration

ATMS.com & 168bank.com Clearing Interface: Direct API connectors replacing traditional SwitchCode gateways, enabling real-time settlement between participating banks and digital wallets within the ecosystem.

Unified Clearing Engine: Orchestrates batch and instant clearing cycles, supports ISO 20022 messaging, SWIFT MT and MX formats, as well as domestic clearing standards (ACH, SEPA, CNAPS).

Dual-Ledger Reconciliation: Maintains synchronized on-chain and off-chain ledgers for audit-grade reconciliation, with automated exception handling and retry logic.

Dynamic Risk & Compliance Checks: Real-time AML/KYC screening and transaction limit enforcement using ATMS.com's capability, integrated with global watchlists and sanctions databases.

Flexible Settlement Modes: Supports gross, net, and hybrid settlement models; configurable per corridor or currency pair, including CBDC rails and stablecoin clearing.

Embedded Liquidity Management: Automated funding of settlement accounts via integrated liquidity pools, minimizing counterparty risk and optimizing capital usage.

### SIMless Digital Identity & Connectivity

Phone Number Replacement: Leverage user-centric DIDs as global addressing identifiers, eliminating the need for traditional phone numbers and physical SIM cards.

eSIM & eUICC Emulation: Integrate embedded UICC functionality within the BEI Chip for secure remote provisioning of carrier credentials via the platform's identity abstraction layer.

Decentralized P2P Discovery & Messaging: Utilize our OmniConnect mesh network overlay for voice, SMS, and data transmission directly between DIDs, with automatic fallback to edge caching or satellite links.

Global Roaming & Network Slicing: Abstract underlying MNO networks and slices; the resource manager dynamically selects optimal connectivity paths (5G, Wi-Fi, LPWAN) without user reconfiguration.

Adaptive QoS & Tokenized Billing: Real-time monitoring on-chip of latency, bandwidth, and energy metrics, enabling on-demand micropayments and dynamic network quality adjustments via native tokens.

Privacy & Regulatory Overlay: End-to-end encryption of signaling and metadata, with selective disclosure modules for lawful intercept and compliance, while maintaining user sovereignty over data.

### One-Click Omniconnect Gateway

Universal Access Button: A single integration point on any platform or website, generating a secure session token that authenticates the user into the Human-Sovereign Ecosystem.

Intelligent Federation Router: Dynamically resolves and routes user requests to one or more of the 1,700 subsystem modules based on real-time preference vectors and service availability.

Context-Preserving Switch: Maintains user state and preferences across multiple subsystem sessions, enabling instantaneous back-and-forth navigation without re-authentication.

Pre-Fetch & Hot Caching: Proactively loads relevant subsystem data and, when possible, pre-authenticates batches of services to minimize latency for the user's nine hundred ninety-nine potential needs.

Bi-Directional Discovery: Allows subsystems to link back to the originating platform, providing contextual relevance, analytics, and seamless return flows.

Security & Compliance Overlay: Applies end-to-end encryption, real-time compliance checks, and access policies on each cross-module transition.

### Key Innovations, Economic Benchmarks & Historical Positioning

Behavior-Time-Value Engine (BEI Engine): Quantifies human behavior and time into tradable economic value, laying the foundation for all value flows in the ecosystem.

BEISIGN Dynamic Behavior Signature: Cross-node identity authentication based on time and actions, ensuring immutability and trust across all modules.

ReadName Decentralized Positioning Protocol: A global behavior-driven location service without reliance on centralized satellites.

SIM-Free Communication: Embeds network protocol within sovereignty domains, saving an estimated $2.5 B in SIM production and $1 B in distribution annually, reducing 50 kt of electronic waste and unlocking $10 B in remote connectivity value.

Domain Bank: User-expandable digital territories enabling autonomous transactions, inheritance, and governance in a personalized digital realm.

TimeCoin Clearing Network: Real-time behavior-driven settlement replacing SWIFT, saving $4 B annually, unlocking $300 B liquidity, and catalyzing over $500 B in new economic activity.

Behavior-Edge Chip (BEI Chip): Processes approximately one billion behavior events per watt; 20% more energy-efficient than TSMC 5 nm and 40% lower inference latency than NVIDIA Ampere.

Patent Ecosystem: Hundreds of USPTO and international patents covering thousands of systematic inventions, securing unlimited development resources.

BEISIGNSIDE Fair Trade Verification: Extends behavior and social graph verification to significantly reduce fraud in finance, supply chains, and digital assets.

Sovereign Vault & Terra Nova: Combines personal territories with green organic minting (territory tokens+time value), offering sustainable alternatives superior to traditional mining. Global Sovereign Energy Network: A one thousand six hundred ninety-nine node 3D mesh interweaving dynamic behavior and value flows, delivering local impact with global coordination.

What is claimed is:

1. A method for providing a user-centric integration platform, comprising: generating a per-user sovereignty digital identity via multi-party computation and BEISIGN root anchors; dynamically mapping user-specific needs to a registry of subsystem modules; orchestrating multi-currency and multi-utility transactions through a seamless UX gateway; and enforcing dynamic compliance across governmental jurisdictions.

2. A user-centric integration system comprising: an identity abstraction module configured to generate a per-user sovereignty digital identity via multi-party computation and BEISIGN root anchors; a dynamic ecosystem mapping engine configured to dynamically map user-specific needs to a registry of subsystem modules; a multi-currency resource manager configured to manage multi-currency and multi-utility transactions; a seamless UX gateway configured to orchestrate user-facing transaction and service actions; a data security framework; and institutional and regulatory integration connectors configured to support dynamic compliance across governmental jurisdictions.

3. A non-transitory computer-readable medium storing instructions that, when executed by one or more processors, cause the one or more processors to: generate a per-user sovereignty digital identity via multi-party computation and BEISIGN root anchors; dynamically map user-specific needs to a registry of subsystem modules; orchestrate multi-currency and multi-utility transactions through a seamless UX gateway; and enforce dynamic compliance across governmental jurisdictions.

4. The method of claim 1, wherein generating the per-user sovereignty digital identity comprises using social and biometric recovery mechanisms.

5. The method of claim 1, wherein dynamically mapping user-specific needs comprises maintaining a registry of at least 1,700 subsystem modules covering three hundred sixty-five industries and nine hundred ninety-nine user vectors.

6. The method of claim 1, wherein orchestrating multi-currency and multi-utility transactions comprises supporting digital assets, fiat currencies, central bank digital currencies, and off-chain utility networks.

7. The method of claim 1, wherein the seamless UX gateway presents human-readable actions and hides blockchain technical details from an end user.

8. The method of claim 1, wherein enforcing dynamic compliance comprises using a data security framework employing end-to-end encryption, zero-knowledge proofs, and secure hardware enclaves.

9. The method of claim 1, further comprising generating up to nine hundred ninety-nine personalized portals per user with dynamic theming and layout.

10. The method of claim 1, further comprising accelerating cryptographic operations and artificial-intelligence inference tasks by a BEI Chip Engine.

11. The method of claim 1, wherein orchestrating multi-currency and multi-utility transactions comprises integrating banking clearing through real-time settlement connectors.

12. The method of claim 1, further comprising providing SIM-free connectivity that leverages decentralized identifiers and embedded UICC emulation for global access.

13. The method of claim 1, wherein the seamless UX gateway comprises an OmniConnect Gateway providing a universal access button and intelligent federation routing.

14. The method of claim 1, wherein enforcing dynamic compliance comprises real-time AML/KYC screening and tax reporting modules.

15. The method of claim 1, further comprising providing nation-building modules comprising constitutional governance, monetary policy, and public service infrastructure.

16. The method of claim 1, wherein a data architecture of the platform employs a distributed mesh, event-driven streams, and a federated metadata catalog.

17. The method of claim 1, further comprising generating real-time insights and personalized recommendations by cross-module analytics pipelines.

18. The system of claim 2, wherein the identity abstraction module is implemented via a hardware-enforced secure enclave.

19. The system of claim 2, wherein the multi-currency resource manager integrates SWIFT, SEPA, ACH, and CIPS financial rails.

20. The system of claim 2, wherein the user-centric integration system is deployed across a decentralized mesh network ensuring high availability.
